(19) United States
(12) Patent Application Publication
(10) Pub. No.: US 2010/0332531 A1
(43) Pub. Date: Dec. 30, 2010

(54) Batched Transfer of Arbitrarily Distributed Data

(75) Inventor: Ashutosh Galande, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/492,675

(22) Filed: Jun. 26, 2009

(51) Int. Cl. G06F 17/30

(52) U.S. Cl. 707/770; 709/231

(57) ABSTRACT

Batched data transfer may be provided. Data, such as logging data amassed by a web site server, may be distributed among a plurality of database servers. A client may request access to some and/or all of that data. The amount of data may require dividing the data into batches comprising a portion of data from each of the database servers. The batches of data may be transferred to the client and may each cover a specified period of time and a state variable may be used to store the maximum time of data that has been received by the client.

### RELATED APPLICATIONS

Related U.S. patent application Ser. No. ______, filed on even date herewith entitled “Web Usage Pattern Insight Platform,” assigned to the assignee of the present application and having attorney docket number 14917.1299US01/MS327291.01, is hereby incorporated by reference.

Related U.S. patent application Ser. No. ______, filed on even date herewith entitled “Platform for Configurable Logging Instrumentation,” assigned to the assignee of the present application and having attorney docket number 14917.1301US01/MS327294.01, is hereby incorporated by reference.

Related U.S. patent application Ser. No. ______, filed on even date herewith entitled “Best-Bet Recommendations,” assigned to the assignee of the present application and having attorney docket number 14917.1303US01/MS327295.01, is hereby incorporated by reference.

Related U.S. patent application Ser. No. ______, filed on even date herewith entitled “______,” assigned to the assignee of the present application and having attorney docket number 14917.1305US01/MS327316.01, is hereby incorporated by reference.

Related U.S. patent application Ser. No. ______, filed on even date herewith entitled “Load-Balancing and Scaling for Analytics Data,” assigned to the assignee of the present application and having attorney docket number 14917.1306US01/MS327318.01, is hereby incorporated by reference.

### BACKGROUND

Batch transfer of arbitrarily distributed data is a process for abstracting scalability aspects of storing data in multiple databases. In some situations, a distributed database is used to store scalable, large-volume data. For example, an information management portal may store vast amounts of data related to accounts, content, and activities. Thus, the conventional strategy is to provide an application server that only provides access to the data via preconfigured Application Programming Interfaces (APIs). This often causes problems because the conventional strategy does not allow users to work with the raw data, but instead forces them into predefined business logic patterns. Furthermore, scaling the databases by adding additional storage can require reconfiguration of client applications. For example, adding a new data access API may require a new version of an access application to be distributed and installed.

### SUMMARY

Batch transfer of arbitrarily distributed data may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Batched data transfer may be provided. Data, such as logging data amassed by a web site server, may be distributed among a plurality of database servers. A client may request access to some and/or all of that data. The amount of data may require dividing the data into batches comprising a portion of data from each of the database servers. The batches of data may be transferred to the client and may each cover a specified period of time and a state variable may be used to store the maximum time of data that has been received by the client.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a chart illustrating creation of a state variable;

FIG. 3 is a flowchart of a method for providing batched data transfer; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Batched data transfer may be provided. Consistent with embodiments of the present invention, large amounts of data may be distributed across multiple physical database servers. Clients may wish to access this raw data without being forced to use predefined queries that may limit which and/or how much data may be retrieved. For example, a server farm may log data associated with all visitors to web sites hosted by the server farm such as who visited the site, what did they search for, what did they select, and what documents did view, revise, edit, find useful, and like or not like. A client whose site is hosted by the server farm may wish to access all data related to searches issued on their web site, but this data may consume large amounts of storage and be distributed among multiple database servers located at the same hosting facility and/or located elsewhere and connected via a network such as the Internet. The site farm may use a hosting solution product operative to log information about the visitors and the visitors' activities such as Microsoft® Office Sharepoint® Server (MOSS), produced and sold by Microsoft® Corporation of Redmond, Wash.

Clients interested in analyzing the collected data may wish to combine data from several different visitors in order to analyze relationships and/or trends. To facilitate this, the data may be exposed as a single logical view to the client. That is, the client may view the multiple database stores as a single storage device from which the client may request all and/or a part of the logged data. The data may then be divided into batches for transfer to the client in manageable chunks. For example, data may be divided according to a timestamp associated with each piece of data. That is, a client may receive all the data logged between a minimum time and a maximum time in several batches.

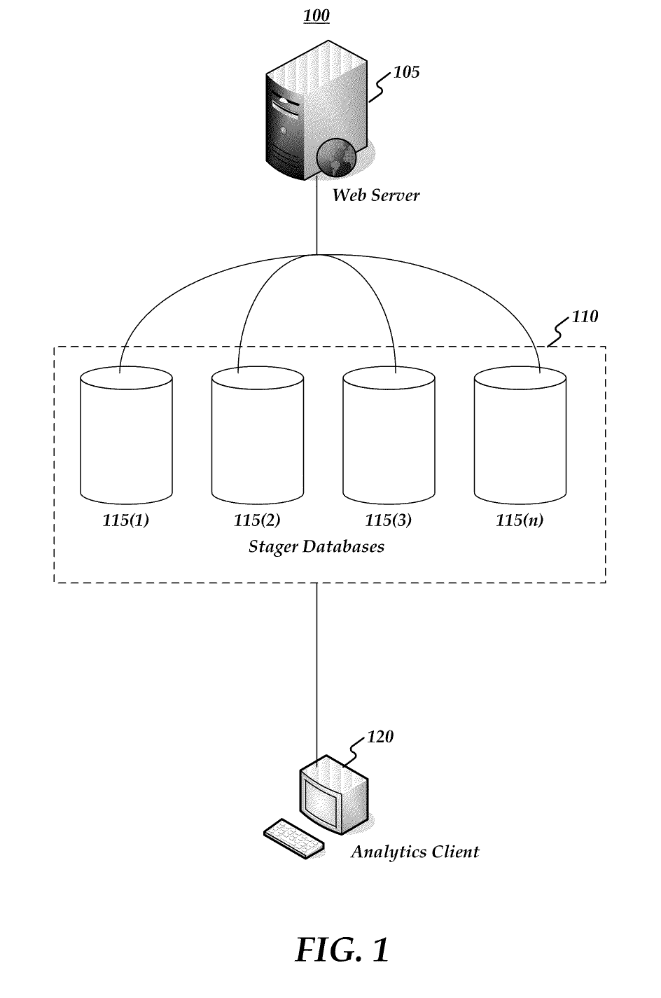

FIG. 1 is a block diagram of an operating environment 100 comprising a web server 105, a plurality of stager databases 110, and an analytics client 120. The plurality of stager databases may include a first database 115(1), a second database 115(2), a third database 115(3), and/or more databases represented by a database 115(n). Web server 105, stager databases 110, and analytics client 120 may be operatively connected, for example, via a computing network.

Web server 105 may be operative to collect data associated with visitors to a hosted web site and distribute that data to stager databases 110. Each visitor to the web site may be associated with a user ID. Logging data associated with that user ID may be transmitted to one of stager databases 110 as the visitor interacts with the web site. Consistent with embodiments of the invention, the data may be distributed to stager databases 110 at the end of the visitor's session. For example, the visitor may load the website, perform a search, select and review several results, and/or provide feedback on the search results. Logging data may be associated with each of these actions and may be transmitted individually as each action is completed and/or as a whole, associated with the overall user session, once the visitor leaves the site.

Each database of stager databases 110 may comprise a table schema describing the structure for storing the data. The schema may be described in a formal language supported by the database management system. For example, the schema may define the tables, the fields in each table, and the relationships between fields and tables. Consistent with embodiments of the invention, each database of stager databases 110 may comprise the same schema; that is, each database may comprise tables having the same names, fields, constraints, and/or relationships. Consistent with further embodiments of the invention, some and/or all of the databases in stager databases 110 may comprise differing schemas comprising different table structures.

Distribution of the data among stager databases 110 may be performed by web server 105 and/or a master database server such as first database 115(1). The distribution may be according to any number of algorithms, such as a round robin scheme whereby each database 115(1), 115(2), 115(n), etc each receives data in turn. Consistent with embodiments of the invention, distribution may rely on a resource calculation, such as a processor load or amount of free space available on each of stager databases 110. The data may be assigned an identifier as it is stored comprising a sequential number operative to aid in ordering the data.

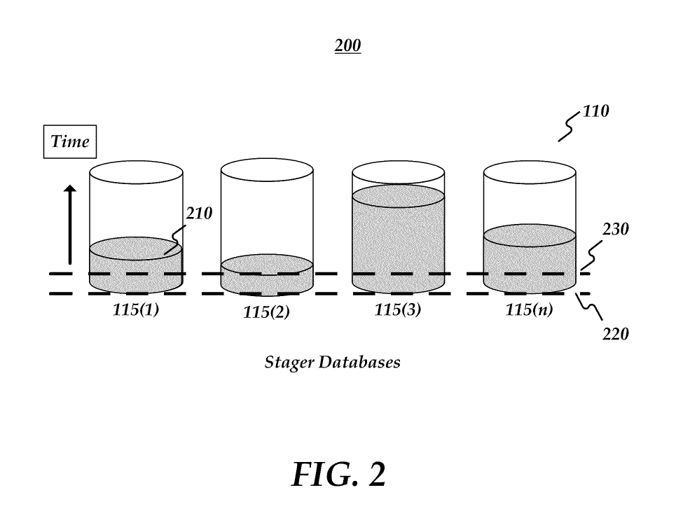

FIG. 2 is a chart illustrating creation of a state variable. Consistent with embodiments of the invention, analytics client 120 may request a set of data from stager databases 110. Data stored in stager databases 110, such as data stored in first database 115(1) represented by shaded area 210, may be associated with occurrence times and may be evaluated to determine a minimum time 220 and/or a maximum time 230. Minimum time 220 may comprise an earliest time associated with data in any of stager databases 110 and maximum time 230 may comprise a most recent time associated with data in any of stager databases 110.

For example, data in stager databases 110 may comprise data stored on June 3. First database 115(1) may comprise data logged between 8:00 A.M. and 8:30 A.M, second database 115(2) may comprise data logged between 7:50 A.M. and 8:15 A.M, and third database 115(3) may comprise data logged between 8:20 A.M. and 8:45 A.M. In this example, minimum time 220 may comprise 7:50 A.M. and maximum time 230 may comprise 8:45 A.M., representing a range of time for which data is available across the plurality of stager databases 110.

A state variable may be created and associated with the transfer of data to the requesting client, such as analytics client 120. The state variable may comprise minimum time 220, maximum time 230, and/or a time corresponding to the latest data transmitted to the client. For example, analytics client 120 may receive a first batch of data from stager databases 110 comprising data from 7:50 A.M. through 8:05 A.M from second database 115(2) and data from 8:00 A.M. through 8:05 A.M from first database 115(1). The state variable may then be updated to store that analytics client 120 has received data through 8:05 A.M. The next batch of data transferred to analytics client 120 may then resume at 8:05 A.M.

Consistent with embodiments of the invention, the state variable may be stored on analytics client 120, one and/or more of stager databases 110, and/or a separate location, such as web server 105 or another computing device. Multiple clients may request data from stager databases 110 and each may utilize its own state variable for tracking the data transfer.

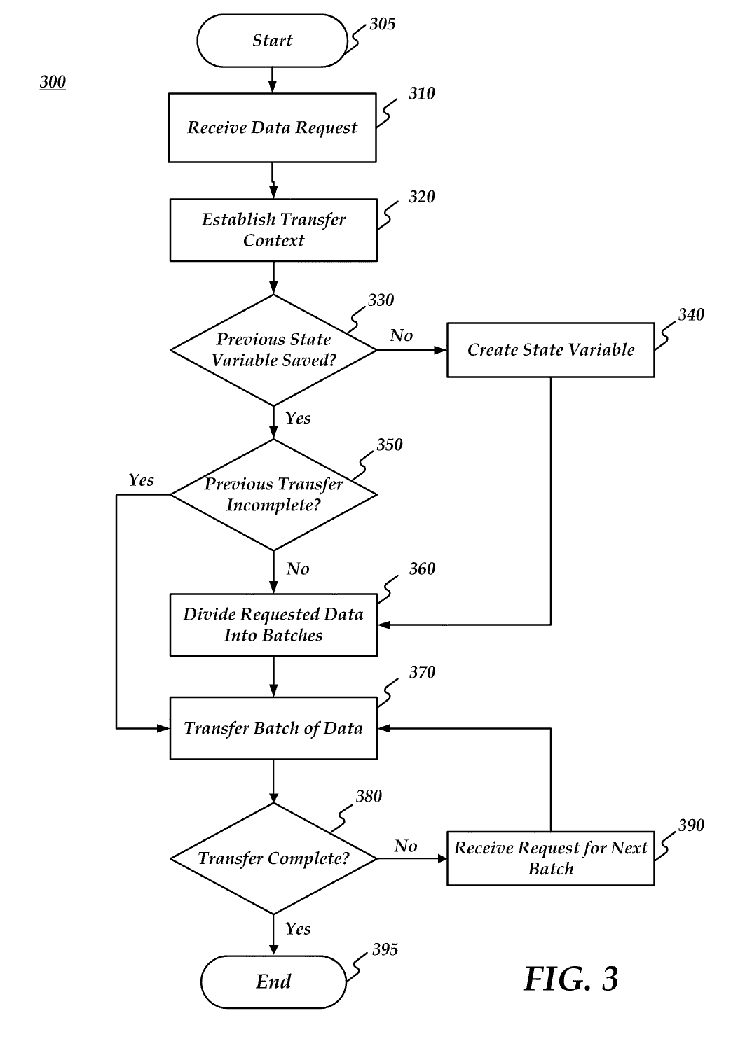

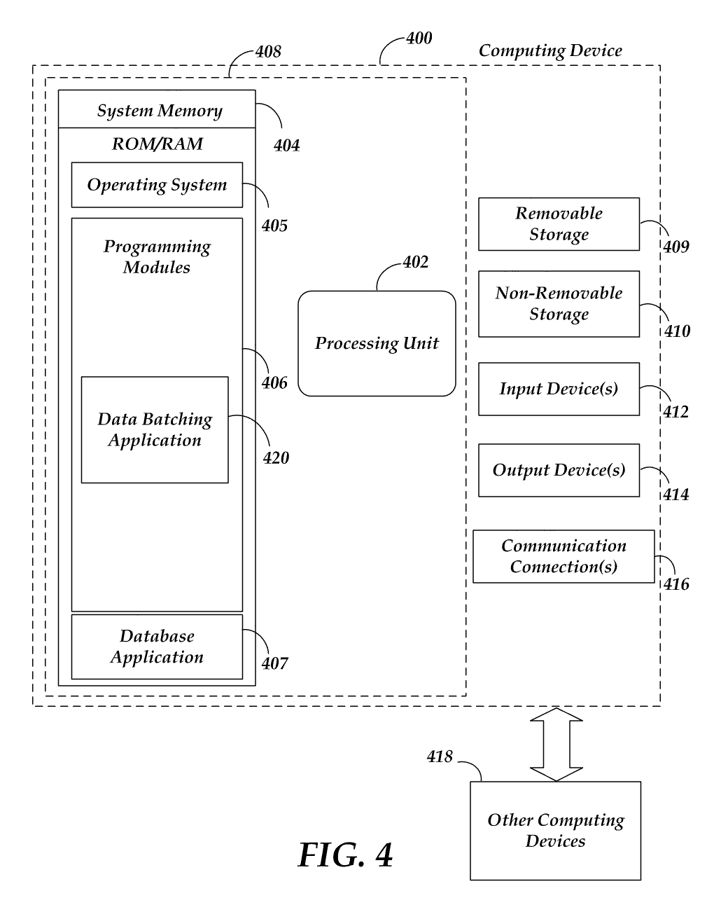

FIG. 3 is a flow chart setting forth the general stages involved in a method 300 consistent with an embodiment of the invention for providing batched data transfer. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may receive a data request. For example, stager databases 110 may receive a request from analytics client 120 for all and/or some of the data stored in stager databases 110.

From stage 310, where computing device 400 received the data request, method 300 may advance to stage 320 where computing device 400 may establish a transfer context. For example, analytics client 120 may negotiate transfer details with stager databases 110, such as identifying which data analytics client 120 desires and/or how many data sets analytics client 120 already has. Consistent with embodiments of the invention, establishing the context may comprise establishing a transfer size that the requesting client may accept. For example, the transfer size may comprise a number of rows or a storage size (e.g. five megabytes). An available bandwidth for data transfer between stager databases 110 and analytics client 120 may be factored in to establishing the transfer size, such as to avoid network timeouts.

The transfer context may also comprise a minimum time and maximum time for the data as specified by the client. For example, analytics client 120 may establish a transfer context specifying 8:00 A.M. through 8:15 A.M and stager databases 110 may retrieve data associated with that time period. The client may re-establish the same transfer context on a subsequent transfer in order to receive the same data again.

Once computing device 400 establishes the transfer context in stage 320, method 300 may continue to stage 330 where computing device 400 may determine whether a previous state variable associated with transferring data to the requesting client has been saved. For example, a state variable comprising a maximum time of data received by the client may be stored in stager databases 110 and/or analytics client 120.

If no state variable is saved, method 200 may advance to stage 340 where computing device 400 may create a state variable. The state variable may identify a minimum event occurrence time and a maximum event occurrence time of data available in stager databases 110. The state variable may also comprise data identifying the most recent data transferred to the requesting client. Consistent with embodiments of the invention, a state variable may be shared among multiple clients. For example, a first client may receive a portion of the requested data before the state variable is copied and/or moved to a second client. The second client may then use the state variable to resume and/or complete the transfer of the requested data. Further consistent with embodiments of the invention, a state variable stored by one and/or more of stager databases 110 may be associated with a password such that any client may provide the associated password and begin and/or resume a data transfer associated with that state variable.

If, however, a saved state variable is found, method 200 may advance to stage 350 where computing device 400 may determine whether a previous transfer to the requesting client is incomplete. For example, analytics client 120 may have aborted a transfer of a batch of data. Analytics client 120 may establish a transfer context identifying a time range of requested data encompassing at least some of the same data as a previous transfer. Computing device 400 may determine that a saved state variable identifies a batch of data within that time period that had not been fully received by analytics client 120.

If, at stage 350, computing device 400 determines that a previous transfer was not incomplete, or after creation of a new state variable at stage 340, method 300 may advance to stage 360 where computing device 400 may divide the requested data into batches. For example, analytics client 120 may request data encompassing a 24-hour period from stager databases 110. Data stored in stager databases 110 may be ordered according to an event occurrence time associated with each piece of data, enabling stager databases 110 to transfer the data to analytics client 120 in sequential order even when pulling data from different physical storage devices.

The data comprising the 24-hour period may be divided into batches according to a number of algorithms. For example, stager databases 110 may use a default number of data rows and/or a maximum data size per batch. Computing device 400 may pull data in order from each of the databases in stager databases 110 for dividing into each batch. For example, computing device 400 may pull a first data row from first database 115(1) associated with an event time of 8:01, a second data row from third database 115(3) associated with an event time of 8:03, a third data row from third data database 115(3) associated with an event time of 8:04, a fourth data row from second database 115(2) associated with an event time of 8:07, and so forth.

Once the data is divided into batches at stage 360 or after a data batch is identified as part of an incomplete transfer at stage 350, method 300 may advance to stage 370, where computing device 400 may transfer the batch of data. For example, stager databases 110 may send the data across a computer network connection to analytics client 120.

From stage 370, method 300 may advance to stage 380 where computing device 400 may determine whether the transfer is complete. For example, the data transferred in stage 380 may comprise the maximum time of data available in stager databases 110 and/or the maximum time requested by analytics client 120. If the transfer is complete, method 300 may end at stage 395.

Otherwise, method 300 may advance to stage 390 where computing device 400 may wait for the requesting client to request the next batch. For example, analytics client 120 may receive and verify the data transferred at stage 370 before sending a request for the next batch of data to stager databases 110. Once the request for the next batch of data is received, method 400 may return to stage 370 where computing device 400 may transfer the next batch. Consistent with embodiments of the invention, computing device 400 may be operative to transfer the next batch of data at a predetermined time after the previous batch's transfer is complete without waiting for the client to request it.

An embodiment consistent with the invention may comprise a system for providing batched data transfers. The system may comprise a memory storage and a processing unit coupled to the memory storage. The processing unit may be operative to distribute data among multiple database server, receive a request for at least a portion of the data, determine whether the requested portion of the data requires batched delivery, in response to determining that the requested portion of the data requires batched delivery, divide the requested portion of the data into a plurality of batches, and provide a first batch of the requested portion of the data. If the data does not require batched delivery, the processing unit may be operative to deliver all of the requested data in a single transfer. A transfer context may be established specifying an amount of data and/or a minimum and/or maximum time of data available, the type of data to be transferred, such as by specifying tables, columns, times, amounts, and/or row identifiers associated with the desired data.

Another embodiment consistent with the invention may comprise a system for providing batched data transfer. The system may comprise a memory storage and a processing unit coupled to the memory storage. The processing unit may be operative to receive a data transfer request from a client device for data stored in a distributed database system, establish a transfer context, determine whether a state variable associated with a previous data transfer is saved, reuse an existing state variable and/or create a new state variable, divide the requested data into a plurality of batches, and transfer the first batch of the requested portion of the data to the client device. The data division may comprise dividing the data into batches according to, for example, an available data transfer bandwidth, a number of database rows, a default storage size (e.g. a standard transfer size, such as five megabytes), and a storage size requested by the client device.

Yet another embodiment consistent with the invention may comprise a system for providing batched data transfer. The system may comprise a memory storage and a processing unit coupled to the memory storage. The processing unit may be operative to receive a data transfer request for data ordered according to an event time, establish a transfer context with the client device, determine whether a state variable comprising a maximum time associated with a previous data transfer to the client device is saved, create a new state variable if necessary, divide the requested data into a plurality of batches, transfer a first batch of the requested data to the client, wait for a request from the client device to send a second batch of the requested portion of the data, and, in response to receiving the request from the client device, transfer the second batch of data to the client device.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include database application 407. Operating system 405, for example, may be suitable for controlling computing device 400's operation. In one embodiment, programming modules 406 may include a data batching application 420 operative to divide and transfer data. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. data batching application 420) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing batched data transfers, the method comprising:
distributing data among a plurality of database servers;
receiving a request for at least a portion of the data;
determining whether the requested portion of the data requires batched delivery;
in response to determining that the requested portion of the data requires batched delivery, dividing the requested portion of the data into a plurality of batches; and
providing a first batch of the requested portion of the data.

2. The method of claim 1, wherein distributing the data among the plurality of database servers comprises allocating data to the plurality of database servers in a round-robin distribution.

3. The method of claim 1, wherein distributing the data among the plurality of database servers comprises allocating data to at least one of the plurality of database servers according to an available capacity of the at least one database server.

4. The method of claim 1, wherein the database servers share a common database schema.

5. The method of claim 1, wherein the data is ordered by a storage time.

6. The method of claim 1, further comprising establishing a context between a requesting user and the plurality of database servers.

7. The method of claim 6, wherein establishing the context comprises specifying at least one type of data requested.

8. The method of claim 6, wherein establishing the context comprises identifying an amount of data available.

9. The method of claim 6, wherein establishing the context comprises identifying at least one of the following: a minimum time and a maximum time for which data is available.

10. The method of claim 1, further comprising establishing a state variable associated with the batched data transfer.

11. The method of claim 10, wherein the state variable is assigned to a client associated with the data request.

12. The method of claim 11, wherein the state variable identifies a maximum time for which data has been transferred to the client.

13. The method of claim 11, further comprising:
saving the state variable after completion of the batched data transfer; and
reusing the state variable for at least one subsequent data request.

14. The method of claim 13, wherein the state variable is saved to at least one of the following locations: the client and at least one of the plurality of database servers.

15. A computer-readable medium which stores a set of instructions which when executed performs a method for providing batched data transfers, the method executed by the set of instructions comprising:
receiving a data transfer request from a client device for data stored in a distributed database system;
establishing a transfer context with the client device;
determining whether a state variable associated with a previous data transfer to the client device is saved;
in response to determining that a state variable associated with a previous data transfer to the client device is not saved, creating a new state variable associated with the data request;
dividing the requested data into a plurality of batches; and
transferring the first batch of the requested portion of the data to the client device.

16. The computer-readable medium of claim 15, wherein establishing the transfer context with the client device comprises establishing a batch size to be used in dividing the requested data into the plurality of batches.

17. The computer-readable medium of claim 16, wherein the batch size is established according to at least one of the following: an available data transfer bandwidth, a number of database rows, a default storage size, and a storage size requested by the client device.

18. The computer-readable medium of claim 15, wherein the state variable comprises a maximum data time of data received by the client device.

19. The computer-readable medium of claim 18, further comprising:
in response to determining that a state variable associated with a previous data transfer to the client device is saved, resuming the batched data transfer according to the maximum data time of the data received by the client device.

20. A system for providing batched data transfer, the system comprising:
a memory storage; and
a processing unit coupled to the memory storage, wherein the processing unit is operative to:
receive a data transfer request from a client device for data stored in a distributed database system, wherein the distributed database system comprises a plurality of stager databases sharing a common database schema and operative to:
store a plurality of analytics data according to a distribution algorithm, and
order the plurality of analytics data across the plurality of stager databases according to an event time associated with each of the plurality of analytics data,
establish a transfer context with the client device, wherein the transfer context comprises at least one of the following: a type of requested data and a data batch size,
determine whether a state variable comprising a maximum time associated with a previous data transfer to the client device is saved,
in response to determining that a state variable associated with a previous data transfer to the client device is not saved, create a new state variable associated with the data request,
divide the requested data into a plurality of batches according to the data batch size,
transfer a first batch of the requested portion of the data to the client device,
wait for a request from the client device to send a second batch of the requested portion of the data, and
in response to receiving the request from the client device, transfer the second batch of the requested portion of the data to the client device.
